(19) United States
(12) Patent Application Publication
(10) Pub. No.: US 2007/0007775 A1
(43) Pub. Date: Jan. 11, 2007

(54) Rotatable bipolar phased magnetic locking system for door

(76) Inventors: William N. Gallas, Queen Creek, AZ (US); Christopher J. Banyai, Chandler, AZ (US); Todd C. Langley, Gilbert, AZ (US); Karl H. Mauritz, Chandler, AZ (US)

Correspondence Address: TOD R NISSLE, PO BOX 55630, PHOENIX, AZ, 85078, US

(21) Appl. No.: 11/175,914

(22) Filed: Jul. 5, 2005

(51) Int. Cl. E05C 19/16

(52) U.S. Cl. 292/251.5

(57) ABSTRACT

A magnetic entry system utilizes opposing polar magnets. At least one of the magnets is rotatable between a first position in which poles of the magnets attract and a second position in which poles of the magnets repel. The magnets are positioned with respect to one another such that the magnets must be pulled apart along a line of travel that is generally normal to planar opposing surfaces of the mangets.

This invention pertains to locks.

More particularly, this invention pertains to an apparatus and method for locking a door.

Locking systems are known for use in connection with securing doors that are used to access a room in a building structure, to access a cupboard, to access a glove compartment in a vehicle, to access the passenger compartment of a vehicle, to access a passenger compartment on a boat or ship, to access a tackle box, or are used to access other compartments ranging in size from small to large. Doors also range in size from small to large. Some locking systems are manual mechanical systems that are opened and closed manually using a key. Other locking systems employ in part electrical energy to operate the system. For example, the bolt or latch in a lock is opened and closed used a solenoid to displace the bolt between two operative positions. In some cases, electrical energy must be continuously supplied to maintain the bolt in the locked position or to maintain an electro-magnetic latch in locked position, and the electrical energy can only be discontinued when the bolt is moved to the unlocked position. Such a continuous expenditure of electrical energy is not desirable, particularly in the case of an electromagnetic latch which may open if the electrical power system fails and electricity is no longer provided the electromagnetic latch.

Accordingly, it would be highly desirable to provide an improved locking system that would eliminate or- reduce the dependence on electrical energy to operate the system, that would remain in a locked state even if electrical power fails, and that would simplify mechanical displacements required to operate the locking, including eliminating the necessity of longitudinally displacing bolts into and out of metal plates that are mounted on a door frame that houses a door.

Therefore, it is a principal object of the invention to provide an improved locking system for a door.

A further object of the invention is to provide an improved locking system that in operation does not require the longitudinal displacement of a bolt between opened and closed operative positions.

Another object of the invention is to provide an improved locking system that can minimize the expenditure of electricity in operating the system.

A further object of the invention is to provide a locking system that permits components of the system to be mounted in a door and door frame such that the locking system is obscured from view.

These and other, further and more specific objects and advantages of the invention will be apparent from the following detailed description of the invention, taken in conjunction with the drawings, in which:

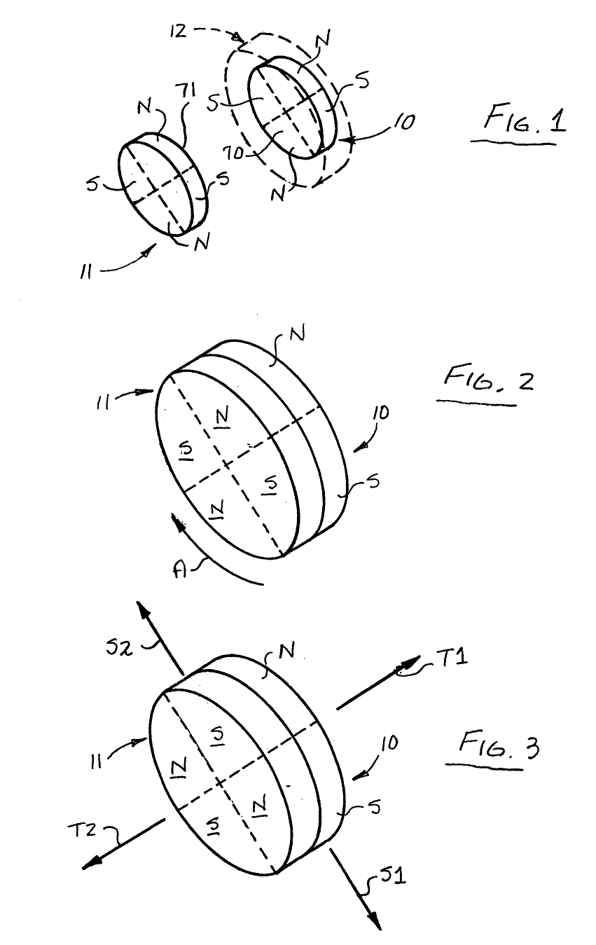

FIG. 1 is a perspective exploded view illustrating a pair of bipolar magnets that can be utilized in the lock system of the invention and that each include four poles;

FIG. 2 is a perspective view illustrating the magnets of FIG. 1 in registration with one another and in an orientation in which the magnetic fields in the magnets function to repel one magnet from the other;

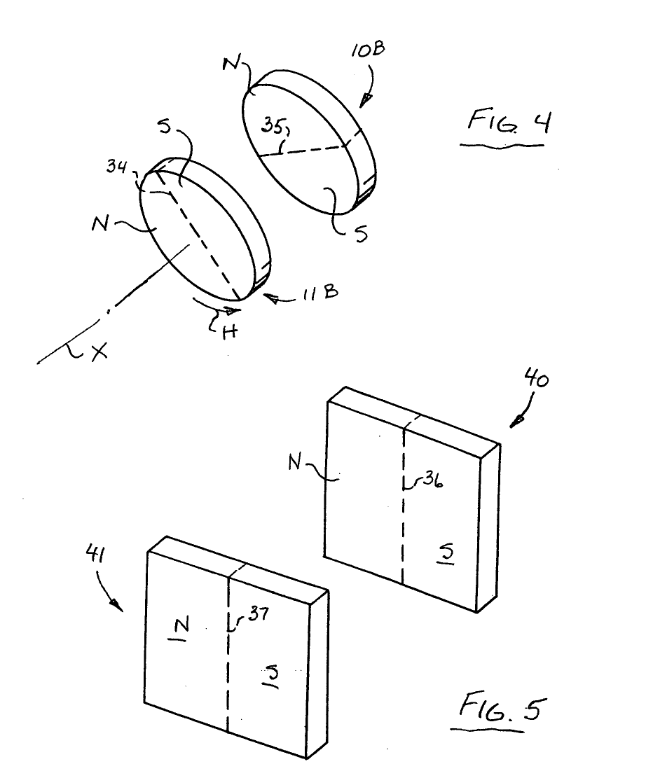

FIG. 3 is a perspective view illustrating the magnets of FIG. 1 in registration with one another and in an orientation in which the magnetic fields in the magnets function to attract one magnet to the other to make it difficult to separate the magnets when displacement forces applied to the magnets are normal to the adjacent circular faces of the magnets;

FIG. 4 is a perspective view illustrating a pair of bipolar magnets that can be utilized in the lock system of the invention and that each include two poles;

FIG. 5 is a perspective view illustrating a pair of bipolar magnets that can be utilized in the lock system of the invention, that each include two poles, and that each have an orthogonal shape;

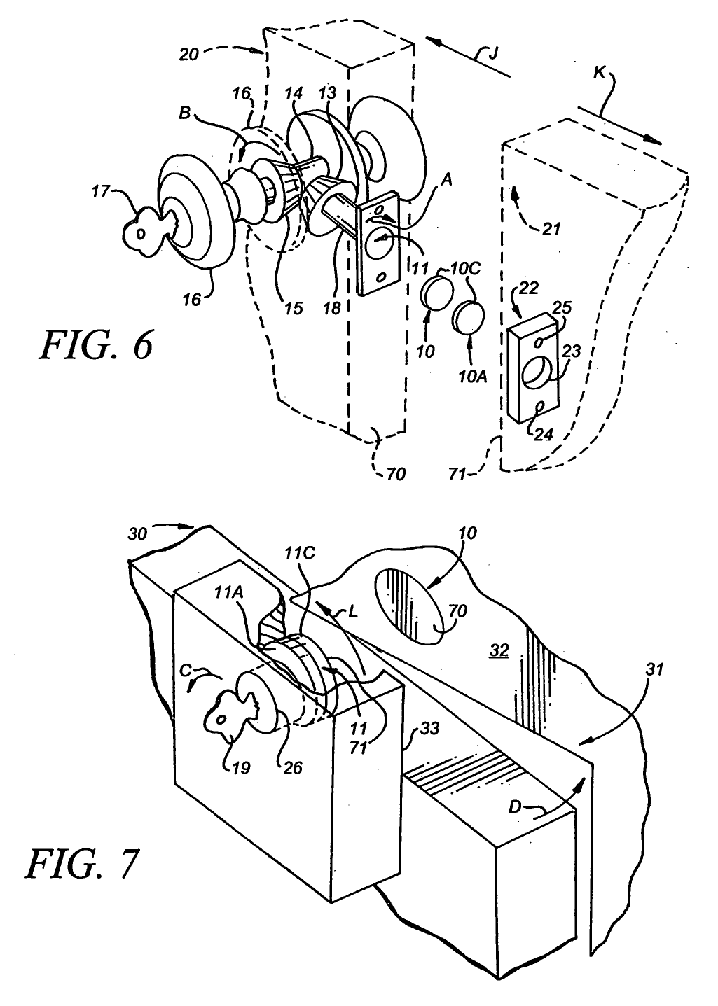

FIG. 6 is a perspective view illustrating a lock system constructed in accordance with the principles of the invention and installed in a pair of sliding doors;

FIG. 7 is a perspective view illustrating an alternate lock system constructed in accordance with the principles of the invention and installed in a door and in the door frame that houses the door;

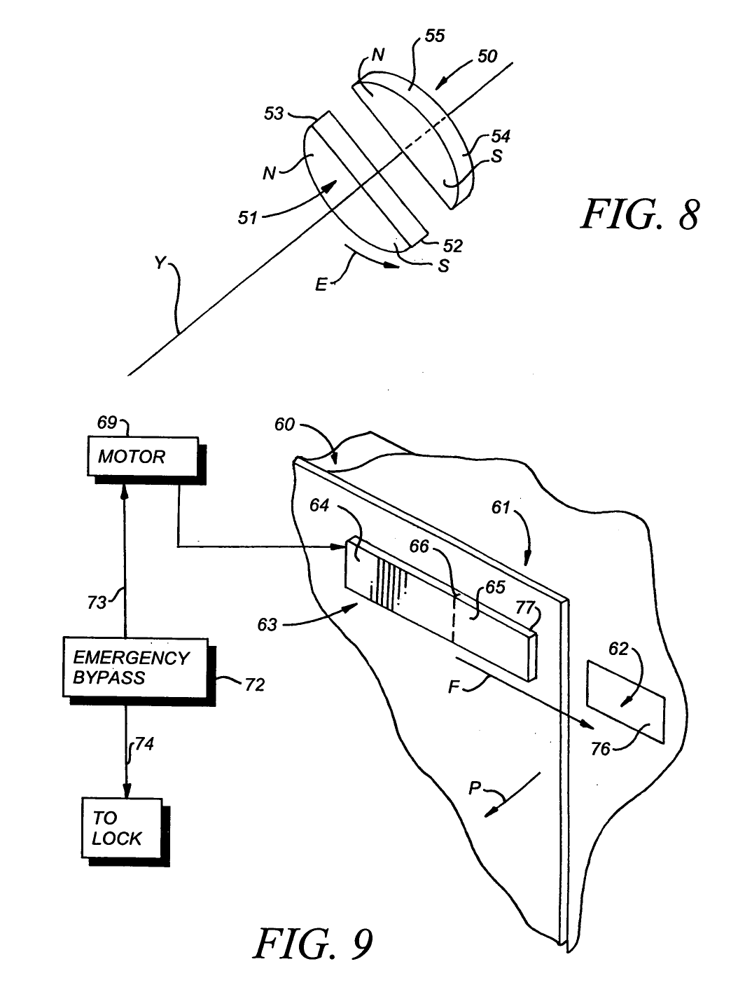

FIG. 8 is a perspective view illustrating a pair of semi-cylindrical bipolar magnets that can be utilized in the lock system of the invention, that each include two poles, and that are not in registration with one another;

FIG. 9 is a perspective view illustrating still another lock system constructed in accordance with the principles of the invention and installed in a door and in the door frame that houses the door; and,

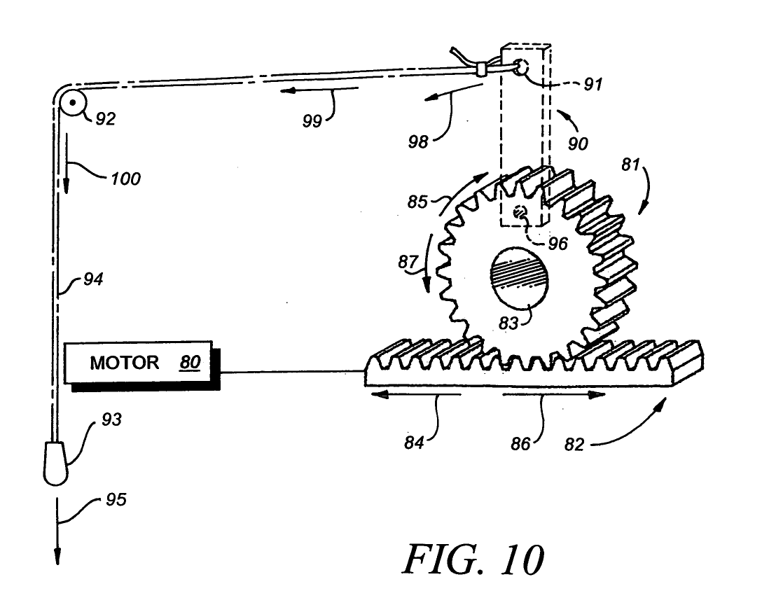

FIG. 10 is a perspective view illustrating an alternate apparatus for rotating a magnet.

Briefly, in accordance with my invention, I provide improvements for an entry system. The entry system includes a door; and, a frame housing the door. The improvements lock the entry system and include a first magnet having at least one north pole and one south pole; a second magnet having at least one north pole and one south pole; apparatus for rotating at least one of the magnets to move the one of the magnets with respect to the other of the magnets between at least two operative positions, a first unlocked operative position in which the magnets repel each other, and a second locked operative position in which the magnets attract each other.

In another embodiment of the invention, I provide an improved method for locking an entry system. The entry system includes a door, and a frame housing the door. The door moves between a first closed position and a second open position and moves in a selected direction of travel when moving from the closed position to the open position. The improved method comprises the steps of mounting in the frame a first magnet having at least one north pole and one south pole, and a face; and, mounting in the door a second magnet having at least one north pole and one south pole, and, a face. The first and second magnets are, mounted such that when the door is in the first closed position, the faces of the magnets are adjacent one another and are generally oriented normal to the selected direction of travel; and, at least the first magnet is rotatable between a first unlocked position in which the first and second magnets repel one another and a second locked position in which the first and second magnets attract one another. The method also includes the steps of moving the door to the closed position; and, moving the first magnet to the second locked position.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a pair of cylindrical magnets 10 and 11 that can be utilized in the invention. Each bipolar magnet 10, 11 includes four poles. Bipolar magnets each includes at least one north pole and at least one south pole. Magnet 10 includes a pair of south poles and includes a pair of north poles, where each pole comprises about one-quarter of the total volume magnet 10. Likewise, magnet 11 includes a pair of south poles and includes a pair of north poles, where each pole comprises about one-quarter of the total volume of magnet 11. In FIG. 1 and the other figures in the drawings, the letter “S” indicates a south pole portion of a magnet and the letter “N” indicates a north pole portion of a magnet. The north pole portion of one magnet repels the north pole portion of another magnet. The south pole portion of one magnet repels the south pole portion of another magnet. The north pole portion of one magnet attracts the south pole portion of another magnet. Magnet 10 includes circular face 70 that is opposed to circular face 71 of magnet 11. If desired, a magnet 10, 11 can be encased or housed in a polymer 12 or other material, in which case the thickness of polymer covering a face 70 ordinarily is relatively thin such that face 71 can positioned relatively close to face 70 to insure that a large proportion of the attractive forces between unlike poles of magnets 10 and 11 is maintained. If the thickness of polymer or other material covering a face 70, 71 (or the space between opposing faces 70, 71) is too great, the attractive forces between magnets 10 and 11 is unnecessarily weakened. A magnet 10 can consist of a single solid piece of material, or can be a laminate and consist of two or more pieces of iron or other magnetic material “stacked” together.

FIG. 2 illustrates the orientation of magnet 10 with respect to that of magnet 11 when the magnets are in the “unlocked” orientation. In FIG. 2, magnets 10 and 11 are in registration with one another, faces 70 and 71 contact each other or are spaced adjacent one another, each pole N of magnet 10 is adjacent and opposed by a pole N of magnet 11, and each pole S of magnet 10 is adjacent and opposed by a pole S of magnet 11. In FIG. 2, like poles repel and magnets 10 and 11 repel one another, and it takes no or little force to displace in any direction magnet 11 from magnet 10.

FIG. 3 illustrates the orientation of magnet 10 with respect to that of magnet 11 when the magnets are in the “locked” orientation. In FIG. 3, magnets 10 and 11 are in registration with one another, faces 70 and 71 contact each other or are adjacent one another, each pole N of magnet 10 is adjacent and opposed by a pole S of magnet 11, and each pole S of magnet 10 is adjacent and opposed by a pole N of magnet 11. In FIG. 2, like poles attract and magnets 10 and 11 attract one another. It takes a significant amount of tensile force(s) T1, T2 to pull magnets apart in the directions indicated by arrows T1, T2. Forces T1 and T2 act in directions normal to circular face 70 and 71 and tend to pull magnets 10 and 11 part. It requires a shear force(s) S1, S2 that has much less magnitude and acts on magnet 10 and/or 11 to cause magnets 10 and 11 to slide apart such that surface 70 (or 71) slides over surface 71 (or 70), or moves in a direction parallel to surface 71.

FIG. 4 illustrates a pair of cylindrical bipolar magnets 10B and 11B that can be utilized in the invention. Each magnet 10B, 11B includes two poles. Magnet 10B includes a single south pole and includes a single north pole, where each pole comprises about one-half of the total volume magnet 10B. Likewise, magnet 11B includes a single south pole and includes a single north pole, where each pole comprises about one-half of the total volume of magnet 11B. The number of north poles in a magnet 10B, 11B can vary as desired, as can the number of south poles; provided, however, that it is desirable, although not necessary, that the size and spacing of the poles in one magnet 10B is equivalent to the size and spacing of the poles in another opposed magnet 11B so that when unlike poles of magnet 10B, 11B are aligned and opposing each other, the attractive forces generated have the greatest possible magnitude. The separation of the south pole of magnet 10B from the north pole thereof is generally indicated by dashed line 35. The separation of the south pole of magnet 11B from the north pole thereof is generally indicated by dashed line 34. Dashed line 34 is perpendicular to dashed line 35. Trying to press magnets 10B and 11B together when they are in the orientation illustrated in FIG. 4 is difficult because a portion of the south pole of magnet 10B tends to repel a portion of the south pole of magnet 11B; and, a portion of the north pole of magnet 10B tends to repel a portion of the north pole of magnet 11B. If, instead, magnet 11B is rotated ninety degrees in the direction of arrow H about axis X, then the south pole of magnet 10B is opposed in its entirely by the north pole of magnet 11B and the north pole of magnet 10B is opposed in its entirely by the south pole of magnet 11B so that magnets 10B and 11B strongly attract one another.

FIG. 5 illustrates a pair of orthogonal bipolar magnets 40 and 41 that can be utilized in the invention. Each magnet 40, 41 includes two poles. Magnet 40 includes a single south pole and includes a single north pole, where each pole comprises about one-half of the total volume magnet 40. Likewise, magnet 41 includes a single south pole and includes a single north pole, where each pole comprises about one-half of the total volume of magnet 41. A magnet 40, 41 utilized in the practice of the invention can take on any desired shape and dimension as long as the opposing magnets can be moved between a first position where the magnets generate forces that cumulatively act to repel one another (or at least act to not attract one another or to attract one another only weakly with forces having a selected desired magnitude) and a second position where the magnets generate forces that cumulatively act to attract one another and that have a selected desired magnitude. The magnitude of the attractive forces when the magnets are in the second position is always greater than the magnitude of the attractive forces when the magnets are in the first position.

FIG. 6 illustrates a lock system constructed in accordance with the invention in a pair of sliding doors 20 and 21. Most entry systems include a single door mounted in a door frame. When an entry system includes two or more doors, one 20 of the two doors can, if desired, and for purposes of discussion and description herein, be considered a door while the other door 21 is considered part of the door frame. This is because one of the key ideas of the invention is believed to be placing in a single door a magnet that interacts appropriately and cooperatively with a magnet in the door “frame” to lock or unlock the single door. There may be door systems with two doors that each swing and open and close and pivot along hinges mounted on vertical sides of the doors, or, there may be door systems that include two or more sliding doors that abut one another or that each move along one of a plurality of adjacent parallel tracks. The key idea of the invention is met as long as a magnet(s) is installed on at least one of the doors and interacts with a magnet or magnet on another door or on a part of the building structure adjacent the door. Thus, in entry ways comprised of multiple doors, one of the doors can be considered a door and the remaining doors can be considered part of the “door frame”.

Plate 22 is inset in and mounted on the vertical edge of door 21 with screws (not shown) that extend through apertures 24 and 25 into door 21. Cylindrical ferrous magnet 10 formed by wafers 10A and 10C is permanently fixedly inset in cylindrical opening 23 and has four poles (a pair of south poles and a pair of north poles) in the manner illustrated in FIGS. 1 to 3. A magnet 11 is permanently fixedly mounted on one end of a rotatable cylindrical shaft 18. Bevel gear 13 is mounted on the other end of shaft 18. Shaft 18, gear 13, and magnet 11 rotate simultaneously. When bevel gear 15 turns, it turns gear 13. In FIG. 6, magnet 11 is in the unlocked position because when doors 20 and 21 are slid together such that the face of magnet 11 is adjacent a face of magnet 10, each north or south pole of magnet 11 is opposed by a like pole of the magnet 10, consequently, magnet 11 is repelled by the magnet 10. The magnet 11 is turned to a locked position by turning key 17 in handle 16 to operate the locking mechanism in handle 16 such that bevel gear 15 is rotated in the direction of arrow B, causing gear 15 to rotate gear 13, shaft 18, and magnet 11. Gear 15 is rotated in the direction of arrow B a distance that is sufficient to rotate gear 13 and magnet 11 in the direction of arrow A through an arc of ninety degrees such that when magnet 11 is adjacent the magnet 10, each north or south pole of magnet 11 is opposed by an unlike pole of the magnet formed by magnet 10. When magnet 11 is in the locked position, when the leading vertical edges 70 and 71 of doors 20 and 21 are adjacent one another, and when magnet 11 is adjacent or contacting the magnet 10, the forces of attraction generated between said magnets makes it difficult to attempt to open doors 20 and 21 in the directions indicated by arrows J and K. Magnet 11 can be rotated by an electrically operated solenoid or by any other desired apparatus or system that can be utilized in place of or in conjunction with the manually operated key system illustrated in FIG. 6.

FIG. 7 illustrates another embodiment of the locking system of the invention. The entry system includes hinged pivoting door 30 and door frame 31. A magnet 10 is fixedly inset in frame 31. A magnet 11 formed by wafers or laminate layers 11A and 11C is mounted in housing 33. Housing 33 is fixedly attached to door 30. Magnet 11 is connected to locking mechanism 26. In FIG. 7, magnet 11 is in the unlocked position because when door 30 is moved in the direction of arrow D to a closed position in frame 31,and the face 71 of magnet 11 is in registration with and contacts or is adjacent the face 70 of magnet 10, each north or south pole of magnet 11 is opposed by a like pole of magnet 10 and, consequently, magnet 11 is repelled by magnet 10. Magnet 11 is turned to a locked position by turning key 19 in locking mechanism 26 in the direction of arrow C to operate the locking mechanism 26 such that magnet 11 is rotated in the direction of arrow C, causing magnet 11 to rotate in the direction of arrow L. When key 19 is turned in the direction of arrow C, the locking mechanism 26 turns magnet 11 in the direction of arrow L through an arc of ninety degrees such that when magnet 11 is adjacent magnet 10, each north or south pole of magnet 11 is opposed by an unlike pole of the magnet 10, and the forces of attraction generated between said magnets makes it difficult to attempt to open door 30 in a direction opposite that of arrow D, which opposite direction is generally perpendicular to faces 70 and 71.

FIG. 8 illustrates a pair of semi-cylindrical magnets 50 and 51 that can be utilized in the invention. Each magnet 50, 51 includes two poles. Magnet 50 includes a single south pole and includes a single north pole, where each pole comprises about one-half of the total volume magnet 50. Likewise, magnet 51 includes a single south pole and includes a single north pole, where each pole comprises about one-half of the total volume of magnet 51. The magnets 50 and 51 differ from magnets 10 and 11 in that when the magnets 50 and 51 are in the unlocked position illustrated in FIG. 8, the semi-circular faces of magnets 50 and 51 are not in registration. In contrast, magnets 10 and 11 remain in registration with circular faces 70 and 71 opposed to one another regardless of whether the magnets 10 and 11 are in the locked or unlocked position. In FIG. 8, magnet 51 is on one side (the “lower” or “back” side in FIG. 8) of axis Y, while magnet 50 is on the other side (the “upper” or “front” side in FIG. 8) of axis Y. Rotating magnet 51 about axis Y in the direction of arrow E through an arc of one hundred and eighty degrees brings magnet 51 into a locking position in registration with magnet 51 such that the south pole of magnet 51 opposes and is adjacent or contacts the north pole of magnet 50 and such that the north pole of magnet 51 opposes and is adjacent or contacts the south pole of magnet 50. When desired, magnet 51 is rotated out of the locking position back to the unlocked position illustrated in FIG. 8.

In the lock system of FIG. 9, a magnet 62 is fixedly inserted and mounted in door frame 61. Elongate orthogonal panel 63 is slidably mounted on door 60 in a sleeve (not shown). Door 60 is pivotally mounted on hinges (not shown) in a conventional manner. The lock system is illustrated in FIG. 9 in an unlocked configuration. A motor 69 or solenoid or other means is used to slide panel 63 in the direction of arrow F to a locked position where the magnet 65 comprising one end of panel 63 is adjacent and in registration with magnet 62. When magnet 65 is adjacent and in registration with magnet 62, the north pole of magnet 65 opposes and is attracted by the south pole of magnet 62, and, the south pole of magnet 65 opposes and is attracted by the north pole of magnet 62. When magnet 65 is in the afore-described locked position, the attractive forces generated between magnets 65 and 62 make it difficult to open door 60 in a direction P that is generally normal to faces 77, 76 of magnets 65 and 62, respectively.

Magnet 65 is connected to and moves simultaneously with portion 64 of panel 63. When magnet 65 is in registration with magnet 62, a section of portion 64 is inside the sleeve (not shown) that is attached to door 60 and that slidably houses panel 63. Motor 69 is used to slide panel in a direction opposite that of arrow F from the locked position back to the unlocked position illustrated in FIG. 9.

FIGS. 6, 7, 9 each illustrate a door-door frame assembly that includes a single lock system. The lock system includes a pair of opposing magnets 10, 11. As would be appreciated by those of skill in the art, a door and door jamb may include more than one lock system to increase the number of pairs of opposing magnets that can be positioned to generate forces of attraction that function to maintain the door in a locked position.

An electrically powered magnetic lock system constructed in accordance with the invention can, as illustrated in FIG. 9, include an emergency bypass system 72 that will, in the event of a power failure, function 73 to provide auxiliary power to operate a motor 69 that normally functions to open (and close) a magnetic lock 62, 65. The emergency bypass system 72 can, if desired, include its own separate motor 69 that is connected 74 to and operates a magnetic lock 62, 65.

In another embodiment of the invention, one or more components of the magnetic lock system are mounted inside a door or door jamb such that the components are not visible. For example, in FIG. 6, the door handle 16 can be eliminated and gear 15 can be mounted inside door 20 and completely beneath the outer surface of the door such that an individual looking at the outer surface of the door can not see gear 15. Gear 15 is then a magnet like magnet 11. Gear 15 can be turned by placing a magnet 1.0 against the outer surface of the door adjacent gear 15 in an orientation that causes magnet 10 to attract magnet 11 and by turning the magnet 10 in the direction of arrow B. Turning magnet 10 causes gear 15 to turn in the direction of arrow B and causes gear 13 and magnet 11 to turn in the direction of arrow A. Turning magnet 10 causes gear 15 to turn because the outer surface of door 20 is thin and because, therefore, gear 15 is relatively close to magnet 10 when magnet 10 is placed against the outer surface of door 20.

FIG. 10 illustrates an alternate apparatus for rotating a magnet 83 utilized in the invention. The apparatus includes rack 82 and pinion 81. Magnet 83 is fixedly mounted in and rotates with pinion 81. Motor 80 or a solenoid is utilized to displace rack 81 in the directions indicated by arrows 84 and 86 to rotate pinion 81 in the directions indicated by arrows 85 and 87, respectively. Alternatively, a mechanical bypass may be provided. One mechanical bypass is illustrated in FIG. 10 and includes rigid arm 90 fixedly secured to pinion 81 by one or more rivets 96 or other fasteners, includes aperture 91 formed through the upper end of arm 90, includes free-wheeling pulley 92, included pliable cord 94, and includes bob 93 connected to the distal end of cord 94. The proximate end of cord 94 threads through aperture 91 and is tied upon itself to secure the proximate end of cord 94 to arm 90. When bob 93 is grasped and pulled in the direction of arrow 95, cord 94 is pulled over free-wheeling pulley 92 and moves in the directions of arrows 99 and 100 to displace arm 90 in the direction of arrow 98 and rotate pinion 81 and magnet 83. Pinion 81 is rotatably mounted on a fixed shaft (not shown).

Having described my invention in such terms as to enable those of skill in the art to make and practice it, and having described the presently preferred embodiments thereof, I claim:

1. In combination with an entry system, the entry system including
a door, and
a frame housing the door
improvements for locking the entry system, said improvements including
(a) a first magnet having at least one north pole and one south pole;
(b) a second magnet having at least one north pole and one south pole;
(c) apparatus for rotating at least one of said magnets to move said one of said magnets with respect to the other of said magnets between at least two operative positions
(i) a first unlocked operative position in which said magnets repel each other, and
(ii) a second locked operative position in which said magnets attract each other.

2. A method of locking an entry system, the entry system including
a door, and
a frame housing the door,
the door moving between a first closed position and a second open position and moving in a selected direction of travel when moving from said closed position to said open position,
the method comprising the steps of
(a) mounting in said frame a first magnet having
(i) at least one north pole and one south pole,
(ii) a face;
(b) mounting in said door a second magnet having
(i) at least one north pole and one south pole,
(ii) a face,
said first and second magnets being mounted such that when said door is in said first closed position,
(i) said faces of said magnets are adjacent one another and are generally oriented normal to said selected direction of travel, and
(ii). at least said first magnet is rotatable between a first unlocked position in which said first and second magnets repel one another and a second locked position in which said first and second magnets attract one another;
(c) moving said door to said closed position; and,
(d) moving said first magnet to said second locked position.
